(19) United States
(12) Patent Application Publication
(10) Pub. No.: US 2011/0011428 A1
(43) Pub. Date: Jan. 20, 2011

(54) AUTOMATIC CHAIN CLEANER FOR BICYCLES

(76) Inventor: Chi-Tung Tao, Taipei (TW)

Correspondence Address: Chi-Tung Tao, 235 Chung - Ho Box 8-24, Taipei, 235, TW

(21) Appl. No.: 12/503,085

(22) Filed: Jul. 15, 2009

(51) Int. Cl. B08B 3/00

(52) U.S. Cl. 134/110

(57) ABSTRACT

An automatic chain cleaner comprises a power source; a first transmission system connected to the power source; a second transmission system; a waste liquid collecting tray connected to the first transmission system for collecting waste liquid; a filter net being installed at a front end of the liquid draining tube for filtering impurities from the waste liquid; a brush roller connected to the waste liquid collecting tray; the rotary shaft being driven by the first transmission system to rotate; the hairs of the brush roller for brushing a chain of a bicycle; a cleaning liquid reservoir filled with cleaning liquid; a pump installed in the cleaning liquid reservoir and connected to the second transmission system and being driven by the second transmission system for pumping cleaning liquid out of the cleaning liquid reservoir; and an upper end of the cleaning liquid reservoir being extended with a nozzle.

### FIELD OF THE INVENTION

The present invention relates to bicycle cleaning, in particular to an automatic chain cleaner for a bicycle, wherein the present invention can be used to clean chains and free wheels of bicycle automatically and easily.

### BACKGROUND OF THE INVENTION

There are some prior arts about the cleaning of chains and free wheels and chain wheels of bicycles, such as GB2405681, in that a bicycle chain cleaner is disclosed. The cleaner is fitted on a spray can of cleaning and lubricant solution by a ring having a screw engaging below an upper edge of the spray can. The chain cleaner comprises a lower half shell and an upper half shell which are articulated around pivot. A chain is placed between the two half shell and trigger is operated by a user so that the two half shell close round the chain and are locked in place by sides that are formed with mutually engaging interlocking contours. The half shells are provided with rotating brushes with tufts which penetrate, when the chain advances in the half shells between links of the chain. Half shells are provided with a flat elongated tray which collect and covers regions where a sprayed solution is dispensed.

However the chains or free wheels cleaning devices are operated manually and can only clean the chains. They are not suitable to clean all the bike transmission devices so that the user must buy different tools for cleaning the different devices. Furthermore, the manual operation device takes great labors and easily dirt the operator's hands.

### SUMMARY OF THE INVENTION

Therefore, the object of the present invention is to provide an automatic chain cleaner, in that the present invention can be used to clean chains, free wheels and chain wheels of bicycle automatically and easily.

According to achieve the defects in the prior art, the present invention provides an automatic chain cleaner, comprising: a power source; a first transmission system connected to the power source; a second transmission system connected to the power source; a waste liquid collecting tray connected to the first transmission system for collecting waste liquid; the waste liquid in the waste liquid collecting tray flowing out from the liquid draining tube, a filter net being installed at a front end of the liquid draining tube for filtering impurities from the waste liquid; a brush roller connected to the waste liquid collecting tray; the rotary shaft being driven by the first transmission system to rotate; the brush roller having a plurality of hairs around the lateral side of the roller; the hairs of the brush roller for brushing a chain of a bicycle; a liquid draining tube installed at a lower side of the brush roller; the waste liquid collecting tray being installed below the brush roller for receiving falling waste liquid from the brush roller; a cleaning liquid reservoir filled with cleaning liquid; a pump installed in the cleaning liquid reservoir and connected to the second transmission system and being driven by the second transmission system for pumping cleaning liquid out of the cleaning liquid reservoir; a lateral side of the cleaning liquid reservoir having an opening; the liquid draining tube being connected to the opening; an upper end of the cleaning liquid reservoir being extended with a nozzle; when the pump acts, the cleaning liquid will be driven to flow to the nozzle; the nozzle facing the hairs of the brush roller so as to spray cleaning liquid toward the hairs; the cleaning liquid will be absorbed by the hairs.

The various objects and advantages of the present invention will be more readily understood from the following detailed description when read in conjunction with the appended drawing.

### BRIEF DESCRIPTION OF THE DRAWINGS

FIG. 1 shows the block diagram of the present invention.

FIG. 2 shows the assembly view of the present invention, where the elements are not fully installed to a box.

FIG. 3 is a perspective view about the brush roller of the present invention.

FIG. 4 is a lateral view of the hairs assembled on the brush roller according to the present invention.

FIG. 5 is another assembly view of the present invention, in that the elements are installed to a box.

FIG. 6 shows another embodiment of the present invention, wherein two motors are used.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

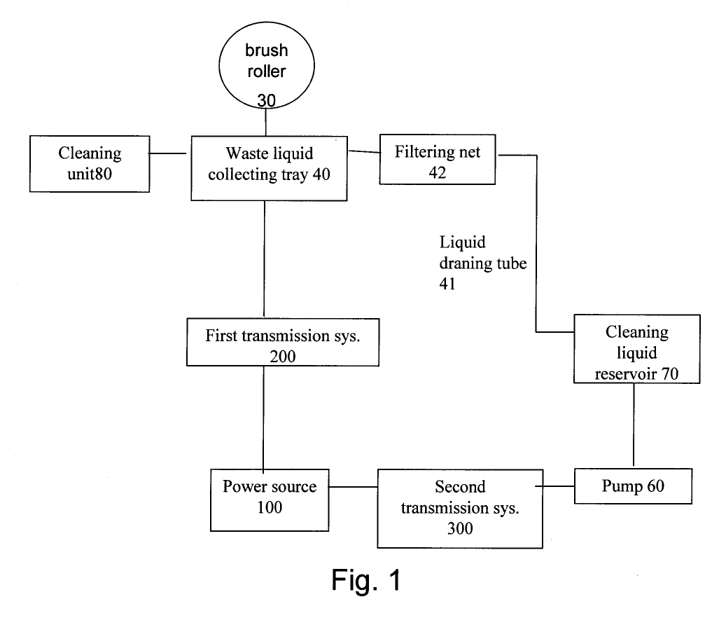

With referring to FIG. 1, a block diagram and a perspective view of the present invention are illustrated. The present invention includes the following elements.

A power source 100 serves for generating power. The power source 100 is connected to a first transmission system 200 and a second transmission system 300.

A waste liquid collecting tray 40 is connected to the first transmission system 100 for collecting waste liquid. The waste liquid in the waste liquid collecting tray 40 can flow out from the liquid draining tube 41. Preferably, a filter net 42 is installed at a front end of the liquid draining tube 41 for filtering impurities from the waste liquid.

A brush roller 30 is connected to the waste liquid collecting tray 40. The rotary shaft 31 is driven by the first transmission system 200 to rotate. The brush roller 30 has a plurality of hairs around the lateral side of the roller 30. The hairs of the brush roller 30 serve to brush a chain of a bicycle. A liquid draining tube 41 is installed at a lower side of the brush roller 30.

A cleaning liquid reservoir 70 is filled with cleaning liquid. A pump 60 is connected to the second transmission system 300 and is driven by the second transmission system 300. The pump 60 serves to pump cleaning liquid out of the cleaning liquid reservoir 70. A lateral side of the cleaning liquid reservoir 70 has an opening 72. The liquid draining tube 41 is connected to the opening 72. An upper end of the cleaning liquid reservoir 70 is extended with a nozzle 74. When the pump 60 acts, the cleaning liquid will be driven to flow to the nozzle 74. The nozzle 74 faces the hairs of the brush roller 30 so as to spray cleaning liquid toward the hairs. The cleaning liquid will be absorbed by the hairs.

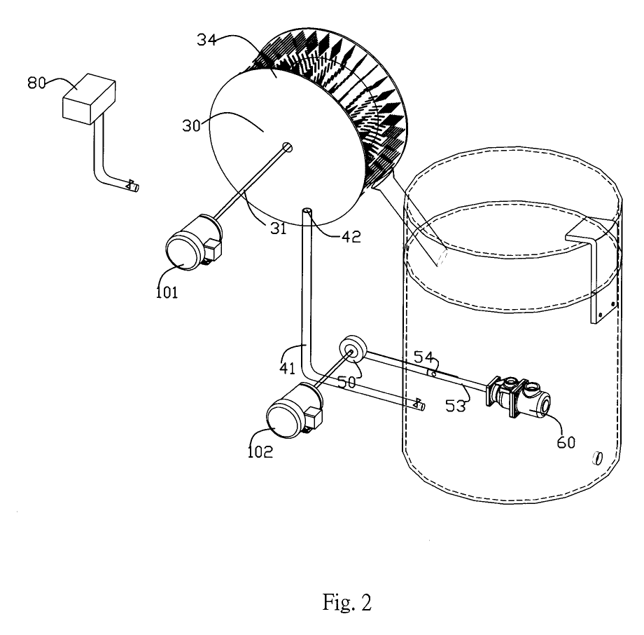

With referring to FIGS. 2, 3 and 4, a detailed structure of those systems illustrated in FIG. 1 is illustrated.

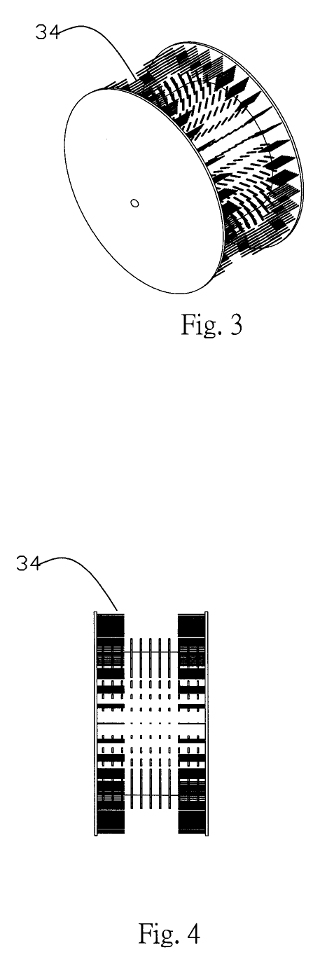

The brush roller 30 is a roller extended with a rotary shaft 31. The rotary shaft 31 is driven by the first transmission system 200 to rotate. The brush roller 30 has plurality of hairs 34 around the lateral side of the roller 30. Referring to FIG. 3, the hair 34 assembly has a U shape cross section.

The waste liquid collecting tray 40 is installed below the brush roller 30 for receiving falling waste liquid from the brush roller 30.

A cleaning unit 80, for example, a sponge or a cloth, is installed beside the brush roller 30. The cleaning unit 80 serves to hold the dripping of the waste liquid and to further clean the chain brushed by the hairs of the brush roller 30.

The power source is a motor 10. A power wire 4 is connected to an external power source and a battery 20 for supplying power to the motor 10.

The first transmission system 200 includes a first pulley 12. An axial center of the first pulley 12 is connected to the spindle 11 of the motor 100. A rotary shaft 31 has one end extended from an axial center of the brush roller 30. Another end of the axial shaft 31 is connected to a roller pulley 32. A flexible extension shaft 33 winds around the first pulley 12 and the roller pulley 32. Thus as the motor 10 runs, the spindle 11 will rotate so as to drive the first pulley 12, the soft wire 33 and the roller pulley 32 to rotate. As a result the brush roller 30 rotates.

The second transmission system 300 has the following elements.

A second pulley 13 is axially connected to the spindle 11 of the motor 10. A second flexible extension shaft 51 winds through the second pulley 13 and then wind through a rotary wheel 50. A first linkage 52 connected to a surface of the rotary wheel 50 at an eccentric position. The first linkage 52 is connected to a second linkage 53 by using a shaft 54. The second linkage 53 axially moves along the shaft 54 and the first linkage 52 also axially moves along the shaft 54.

The pump 60 is an air pump 60 which is driven by the second linkage 53.

A check valve 73 is installed in the opening 72 so that liquid only flows from the liquid draining tube 41 to the cleaning liquid reservoir 70, but can not flow from the cleaning liquid reservoir 70 to the liquid draining tube 41.

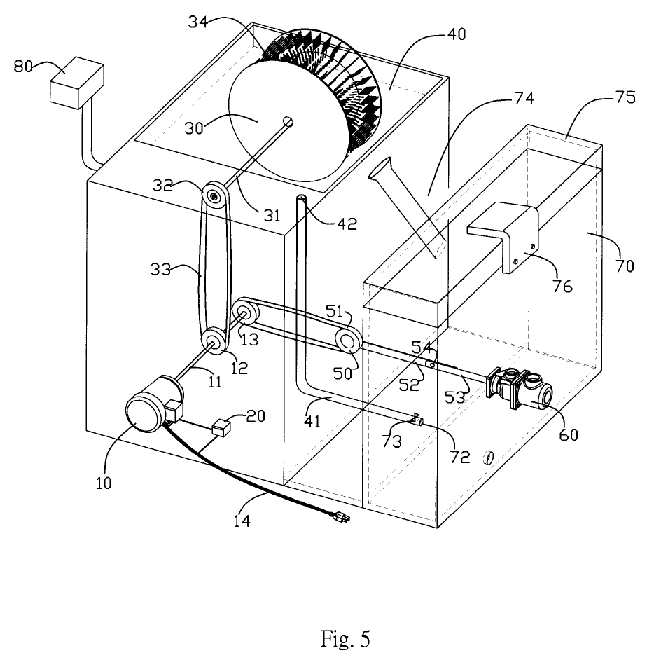

With reference to FIG. 5, it is illustrated that in the present invention, a box 90 can be used to install the motor 10, the first pulley 12, the second pulley 13, the rotary wheel 50, the first linkage 52, and the second linkage 53, etc. A buckle 76 serves to lock and unlock the upper cover of the cleaning liquid reservoir. When the upper cover is unlocked, liquid can be drained out or added thereto. When the upper cover is locked, the cleaner can be operated.

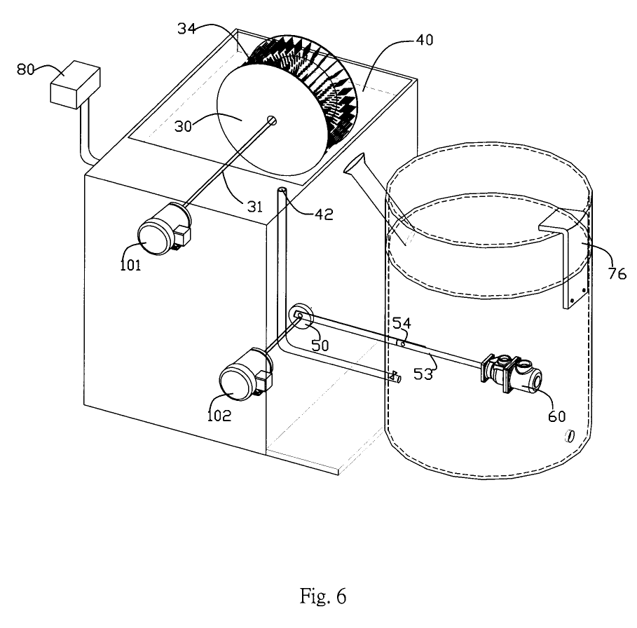

Referring to FIG. 6, the second embodiment of the present invention is illustrated. This embodiment is similar to above mentioned embodiment, and thus in the following, only those differences therebetween are described.

In FIG. 6, it is illustrated that that power source 100 is formed by two motors 101 and 102. The motor 101 serves to drive the brush roller 30 and the motor 102 serves to drive the rotary wheel 50. The first transmission system 200 is the spindle 12 of the spindle 11 of the motor 101. The second transmission system 300 includes a rotary wheel 50, a first linkage 52 and a second linkage 53. The first linkage 52 connected to a surface of the rotary wheel 50 at an eccentric position. The first linkage 52 is connected to the second linkage 53 by using a shaft 54. The second linkage 53 axially moves along the shaft 54 and the first linkage 52 also axially moves along the shaft 54.

Other power source, such as engines, can be used to replace the motor in above embodiments, however motors are preferable in application.

Operations of the present invention will be described herein.

In operation, a bicycle chain (or free wheel or chain wheel, in the following, the chain is used as an example for description). The chain is placed upon the hair 34 of the brush roller 30. Then the power of the motor is actuated. The air pump 60 is actuated by the motor 10 through the second transmission system 300 so that cleaning liquid will spray to the hair 34. Furthermore, the first transmission system is actuated by the motor 10 so as to actuate the brush roller 30 to rotate and the chain is cleaned by the clean liquid in the hair 34 of the brush roller 30. Thus the chain is cleaned. Moreover, the waste liquid from the hair 34 is collected by the waste liquid collecting tray 40 and then is filtered by the filter net 42 and then returns to the cleaning liquid reservoir 70 through the liquid draining tube 41 so as to form a cleaning cycle. Another, the cleaning unit 80 will wipe the chain for removing the dirt and grease on the chain.

Advantages of the present invention are that the present invention can be used to clean chains, free wheels and chain wheels of bicycle automatically and easily.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An automatic chain cleaner, comprising:
a power source;
a first transmission system connected to the power source;
a second transmission system connected to the power source;
a waste liquid collecting tray connected to the first transmission system for collecting waste liquid; the waste liquid in the waste liquid collecting tray flowing out from a liquid draining tube, a filter net being installed at a front end of the liquid draining tube for filtering impurities from the waste liquid;
a brush roller connected to the waste liquid collecting tray; the rotary shaft being driven by the first transmission system to rotate; the brush roller having a plurality of hairs around the lateral side of the roller; the hairs of the brush roller for brushing a chain of a bicycle; a liquid draining tube installed at a lower side of the brush roller; the waste liquid collecting tray being installed below the brush roller for receiving falling waste liquid from the brush roller;
a cleaning liquid reservoir filled with cleaning liquid;
a pump installed in the cleaning liquid reservoir and connected to the second transmission system and being driven by the second transmission system for pumping cleaning liquid out of the cleaning liquid reservoir; a lateral side of the cleaning liquid reservoir having an opening; the liquid draining tube being connected to the opening; an upper end of the cleaning liquid reservoir being extended with a nozzle; when the pump acts, the cleaning liquid will be driven to flow to the nozzle; the nozzle facing the hairs of the brush roller so as to spray cleaning liquid toward the hairs; the cleaning liquid will be absorbed by the hairs.

2. The automatic chain cleaner as claimed in claim 1, further comprising:
a cleaning unit installed beside the brush roller for cleaning the chain brushed by the hairs of the brush roller.

3. The automatic chain cleaner as claimed in claim 1, wherein the brush roller extend with a rotary shaft; the rotary shaft is driven by the first transmission system to rotate; the brush roller has plurality of hairs around the lateral side of the roller;
the power source is a motor; a power wire is connected to external power source and a battery for supplying power to the motor; and
the first transmission system is formed by a first pulley; an axial center of the first pulley is connected to a spindle of the motor; a rotary shaft has one end extended from an axial center of the brush roller; another end of the axial shaft is connected to a roller pulley; a flexible extendable shaft winds around the first pulley and the roller pulley; thus as the motor runs, the spindle will rotate so as to drive the first pulley, the soft wire and the roller pulley to rotate; as a result the brush roller rotates.

4. The automatic chain cleaner as claimed in claim 3, wherein the second transmission system includes:
a second pulley axially connected to the spindle of the motor; a second flexible extension shaft winding through the second pulley and then wind through a rotary wheel; a first linkage being connected to a surface of the rotary wheel at an eccentric position; the first linkage being connected to a second linkage by using a shaft; the second linkage axially moving along the shaft and the first linkage also axially moves along the shaft; and the pump being an air pump which is driven by the second linkage.

5. The automatic chain cleaner as claimed in claim 4, wherein a check valve is installed in the opening.

6. The automatic chain cleaner as claimed in claim 4, wherein a box is used to install the motor, the first pulley, the second pulley, the rotary wheel, the first linkage, and the second linkage.

7. The automatic chain cleaner as claimed in claim 1, wherein
the brush roller extend with a rotary shaft; the rotary shaft being driven by the first transmission system to rotate; the brush roller has plurality of hairs around the lateral side of the roller;
the power source is a first motor and a first motor;
the first transmission system includes a rotary shaft extended from a center of the brush roller and is connected to the spindle of the first motor; and
the second transmission system includes: rotary wheel, a first linkage and a second linkage; the first linkage connected to a surface of the rotary wheel at an eccentric position; the first linkage is connected to the second linkage by using a shaft; the second linkage axially moves along the shaft and the first linkage also axially moves along the shaft.

8. The automatic chain cleaner as claimed in claim 1, wherein the hair assembled on the brush roller has a U shape cross section.
